(19) United States
(12) Patent Application Publication
(10) Pub. No.: US 2023/0361655 A1
(43) Pub. Date: Nov. 9, 2023

(54) MONITORING DEVICE AND METHOD FOR A MECHANICAL DAMAGE, IN PARTICULAR A BREAKAGE, OF A ROTATING SHAFT

(71) Applicant: Rolls-Royce Deutschland Ltd & Co KG, Blankenfelde-Mahlow (DE)

(72) Inventors: Sebastian NOWOISKY, Michendorf (DE); Matthias MANIG, Doberlug-Kirchhain (DE)

(21) Appl. No.: 18/312,345

(22) Filed: May 4, 2023

(30) Foreign Application Priority Data
May 6, 2022 (DE) 10 2022 204 495.9

(51) Int. Cl. H02K 11/21; H02K 11/33; H02K 7/18; H02K 7/14

(52) U.S. Cl. CPC H02K 11/21; H02K 7/14; H02K 7/1823; H02K 11/33

(57) ABSTRACT

A monitoring apparatus for mechanical damage, in particular fracture, of a rotating shaft which is driven by a gas turbine and transmits a torque to a generator, wherein a converter apparatus coupled to the generator generates direct current, characterized by a first measuring apparatus for at least one electrical variable of the generator and/or of the converter apparatus during operation, wherein the torque proportionally depends on the electrical variable, and
a second measuring apparatus for the behaviour of the speed of the generator during operation,
a control apparatus which captures the electrical variable and the speed as measurement variables and,
if at least one predefinable criterion for the mechanical damage, in particular the fracture, of the shaft, in particular threshold values for the measurement variables, is exceeded or undershot, outputs at least one control signal to the gas turbine. The invention also relates to a monitoring method.

This application claims priority to German Patent Application 102022204495.9 filed May 6, 2022, the entirety of which is incorporated by reference herein.

The invention relates to a monitoring apparatus having the features of Claim 1 and to a monitoring method having the features of Claim 17.

Electrical drives require a mechanical shaft power at the input in order to convert this into electrical power. This functionality can be ensured only if the corresponding drive shaft is intact. If there is mechanical damage, for example caused by shaft fracture, the power cannot be dissipated, which can result in damage to surrounding assemblies.

When used in an aircraft drive, a shaft on the output side of a gas turbine (for example with compressor and turbine stages), for example, is used to drive a generator. Such an apparatus is also referred to as a turbo generator. The electrical power produced by the generator (three-phase current) is then converted into direct current with the aid of a converter apparatus.

Mechanical damage, for example the fracture of the shaft, may therefore result in the gas turbine being destroyed on account of the sudden loss of the load, since the blades no longer withstand the high speeds and are radially hurled from the housing. The consequences of such mechanical damage would be very serious, in particular in aircraft drives which have high safety requirements.

It is known practice to detect shaft fracture by mechanically capturing the torsion at the shaft. As a result of this capture, the supply of fuel to the gas turbine is then interrupted, with the result that the generator is no longer driven. It is particularly difficult to implement an electrical switch-off apparatus on account of the very high temperatures in the region of a gas turbine.

Therefore, the object is to provide a robust and efficient monitoring apparatus for mechanical damage, in particular fracture, of a rotating shaft.

The object is achieved by a monitoring apparatus having the features of Claim 1.

The monitoring apparatus is used to detect mechanical damage, in particular fracture, of a rotating shaft which is driven by a gas turbine and transmits a torque to a generator, wherein a converter apparatus coupled to the generator generates direct current.

In this case, the monitoring apparatus uses at least two measurement variables, wherein a first measuring apparatus captures at least one electrical variable of the generator and/or of the converter apparatus during operation. In this case, the electrical variable of the current is proportional to the torque.

A second measurement variable is captured by a second measuring apparatus which detects the behaviour of the speed of the generator during operation.

A control apparatus captures and processes these measurement variables (that is to say the electrical variable and the speed), wherein, if at least one predefinable criterion for the mechanical damage, in particular the fracture, of the shaft is exceeded or undershot, a control signal is output to the gas turbine in order to stop the latter, for example. Threshold values for the measurement variables can therefore be used, in particular, as the criterion, for example.

Fast and robust control can therefore be achieved if there is mechanical damage.

In this case, the at least one electrical variable may comprise at least two time-dependent current intensities on the drive side of the generator and/or the converter apparatus.

Robustness is increased if the control apparatus captures and/or evaluates a reference position or an angle of rotation of the shaft as a further measurement variable. The speed information could also be additionally or alternatively synthesized from the electrical measurement signal. The generator has windings distributed over the circumference, with the result that sinusoidal signals are generated. If the current or the voltage is measured, this signal is sinusoidal, wherein this periodic time signal can be evaluated in order to detect the zero crossings, for example, which constitute pulses. The time between the pulses obtained in this manner is a measure of the speed of the generator. In this case, it is necessary to capture three measured phases in a plurality of lanes at supporting points in order to directly measure a torsional vibration.

The at least one criterion for the mechanical damage may assume different forms in each case.

For example, it is possible to capture the drop in the electrical variable, in particular the current, within or after a predeterminable time window and/or the exceeding of a predeterminable variation range for the electrical variable within a predeterminable time window.

Similarly, it is additionally or alternatively also possible to capture the drop in the speed within or after a predeterminable time window and/or the exceeding of a predeterminable variation range for the speed within a predeterminable time window.

In one embodiment, the determined features from the windowing may be stored in at least one ring memory or ring buffer in order to therefore have the possibility of being able to resort to historical features for the comparison. During the analysis, the current features are compared with limit values and historical features in order to avoid false alarms and to take into account time-variant behaviour of the machine. If the limit values are contravened, the gas turbine is switched off by closing the fuel valve.

It is also possible to capture the increase in an angle of rotation within or after a predeterminable time window and/or the exceeding of a predeterminable variation range for the angle of rotation within a predeterminable time window.

In a further embodiment, the variation range has a frequency, that is to say, if the measurement signal is periodic, undershooting or exceeding of a particular frequency can result in the control signal being output.

Furthermore, in one embodiment, the measurement variables can be used in the time domain as a sliding mean average, a quadratic mean, a crest factor or a variance. If the measurement variables are frequency-dependent, they can be evaluated, for example, using a residual analysis, an order spectrum and/or a continuous optimization algorithm, in particular a TSA algorithm.

In one embodiment, the at least one control signal can also cause the gas turbine to be switched off or shut down in order to prevent possible damage to the gas turbine.

In one embodiment, the control apparatus has means for vector control of the generator.

Embodiments may also have a control apparatus in which means for feature extraction are used within the context of machine learning, and wherein the at least one control signal can be generated on the basis of the feature extraction.

In one embodiment, the generator is in the form of a permanently excited synchronous motor.

It is also possible for the generator and the shaft to be part of a drive of an aircraft, in particular in the form of a turbo generator or part of a test apparatus. An aircraft is understood here as meaning, in particular, aeroplanes (also VTOL) and helicopters.

The object is also achieved by a monitoring method having the features of Claim 17.

The invention will be discussed in connection with the exemplary embodiments illustrated in the figures. In the figures:

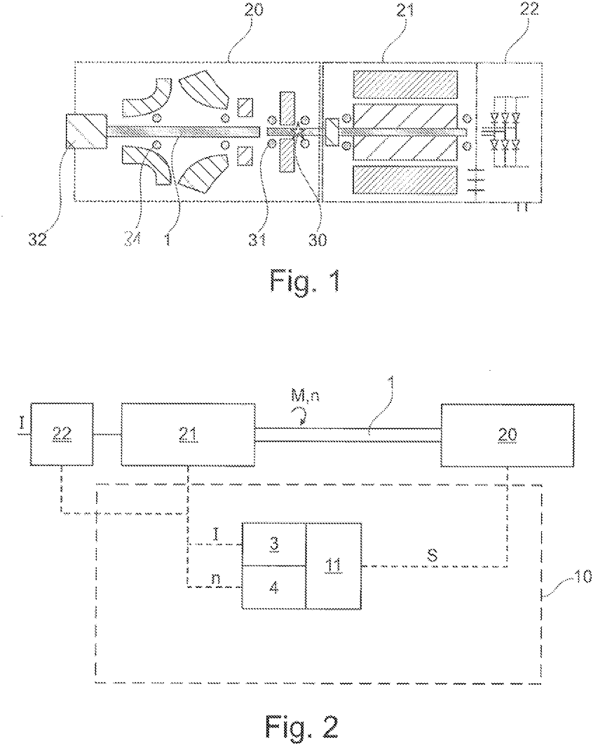

FIG. 1 shows the basic structure of a turbo generator having one location with mechanical damage;

FIG. 2 shows a basic illustration of an embodiment of a monitoring apparatus;

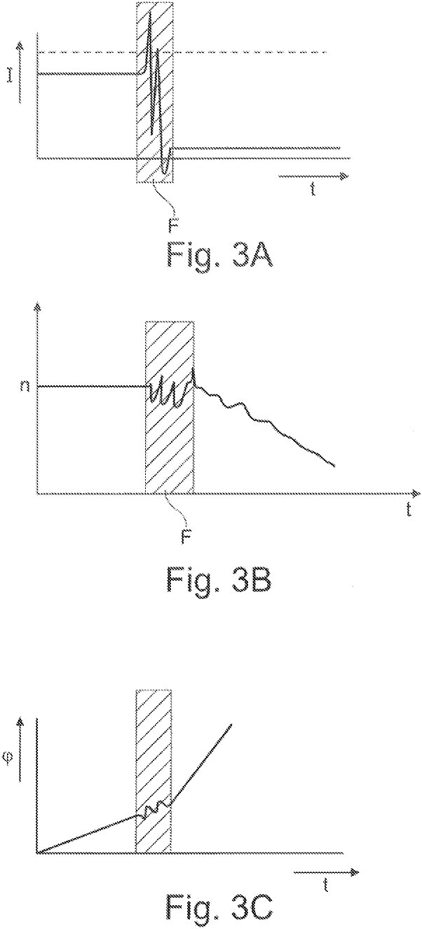

FIG. 3A shows a schematic illustration of a current signal when the mechanical damage occurs;

FIG. 3B shows a schematic illustration of a speed signal when the mechanical damage occurs;

FIG. 3C shows a schematic illustration of an angle of rotation signal when the mechanical damage occurs;

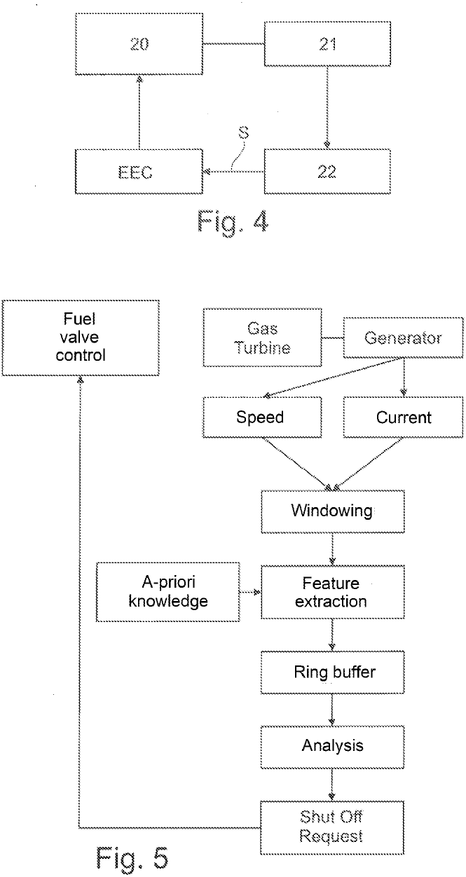

FIG. 4 shows a schematic illustration of an embodiment of a control process;

FIG. 5 shows a schematic illustration of an embodiment of a control process using machine learning.

FIG. 1 illustrates the basic structure of a fundamentally known turbo generator which has a gas turbine 20, a generator 21 and a converter apparatus 22.

The gas turbine 20 having a compressor and a turbine drives the generator 21 via the rotating shaft 1. In this case, the gas turbine 20 is coupled to a starter drive 32.

In this case, the rotating shaft 1 has bearing apparatuses 31 which are illustrated only schematically here.

In this case, the driven generator 21 generates alternating current in a known manner, which is converted into direct current with the aid of the converter apparatus 22.

A problem arises when mechanical damage occurs on the rotating shaft 1, here for example a fracture point 30 at the transition from the gas turbine 20 to the generator 21. If fracture begins, the gas turbine 20 is suddenly missing the load, with the result that the speed of the gas turbine 20 increases very sharply in a very short time. This may result in the destruction of parts of the gas turbine 20. On account of the high speeds, blades may radially break away from the compressor stages and/or the turbine stages, which may result in serious consequences if, for example, such a turbo generator is used in an aircraft, in particular an aeroplane.

The turbo generator illustrated here should be understood merely by way of example since other shaft arrangements are also conceivable in principle. The rotating shaft 1 may be in the form of a single-part shaft or a hollow shaft with two or more parts.

FIG. 2 illustrates an embodiment of a monitoring apparatus 10 which can be used to detect mechanical damage, in particular fracture, of a rotating shaft 1, wherein the shaft 1 is driven by the gas turbine 20.

The shaft 1 rotates at a speed n and transmits a torque M to the generator 21.

In this case, a first measuring apparatus 3 is used to capture the behaviour of at least one electrical variable I of the generator 21 during operation. This electrical variable is the current I here. The torque M transmitted to the generator 21 is proportional to the current I in this case, that is to say there is a dependence between the torque M applied to the generator 21 and the electrical variable I.

The monitoring apparatus 10 also has a second measuring apparatus 4 which is used to capture the behaviour of the speed n of the electrical drive 2 during operation. The connection of the speed capture is only schematically illustrated here; it may be carried out in the generator 21 and/or on the rotating shaft 1 itself.

A control apparatus 11 processes the measurement variables - the electrical variable I and the speed n. If predefinable criteria for the mechanical damage, in particular the fracture, of the rotating shaft 1 are exceeded or undershot, a control signal S is output to the gas turbine 20, which control signal ensures quick switch-off, for example by interrupting the fuel supply. In this case, the control signal S may be transmitted to the EECs (electronic engine controllers) of the gas turbine 20.

The predefinable criteria may be, for example, threshold values for the measurement variables I, n. However, it is possible to use more complex criteria, for example increases or drop rates for the measurement variables, as explained in connection with FIGS. 3A, 3B, 3C.

In this case, it is possible for one embodiment of a control apparatus 11 to use fundamentally known vector control for electrical machines.

Vector control is based on the fact that electrical alternating variables are not used with the temporal instantaneous value thereof, but rather with an instantaneous value that has been adjusted by the phase angle within the period. In this case, the captured multi-phase alternating variables lᵤ, lᵥ, l_{w} of the three-phase current, for example, are transformed as vectors into a two-dimensional d-q system (Clarke-Park transformation). The accordingly transformed values can be compared with target values and then processed by PI controllers.

Applied to the embodiment according to FIG. 2, this means that the alternating variables I are captured by the first measuring apparatus 3 and appropriate transformations are carried out according to the vector control. The manipulated variables which are generated by the vector control in the control apparatus 11 then control, for example, the output of the direct current by the generator 21.

In the embodiment in FIG. 2, the electrical variable I is captured at the generator 21. Additionally or alternatively, the electrical variable I can also be captured at the converter apparatus 22.

FIGS. 3A, 3B, 3C schematically illustrate the time-dependent profiles of different measurement variables and their processing, on the basis of which fracture of the rotating shaft 1 can be determined, for example.

In this case, FIGS. 3A and 3B respectively show the processing of the electrical measurement variable I (FIG. 3A) and of the speed n (FIG. 3B), as is implemented in the exemplary embodiment in FIG. 2, that is to say the measurement variables are captured at the generator 21.

In the event of fracture of the rotating shaft 1, the initially constant value for the current I exhibits strong variations within a narrow time window F and then permanently falls to zero. In this case, the current I is proportional to the torque and the torque M is therefore also finally zero. A torque peak may also occur within the time window F. The first measuring apparatus 3 (see FIG. 2) captures this signal I, for example.

FIG. 3B illustrates the similar process for the speed n of the generator shaft, wherein the initially constant speed n varies within the time window F and then drops towards zero. The second measuring apparatus 4 (see FIG. 2) captures this signal n, for example.

FIG. 3C illustrates a further signal which can be evaluated, in addition to the two signals, for the purpose of monitoring a fracture event. A further measuring apparatus can be used to capture an angle of rotation φ or a reference position of the shaft 1, with the result that the control apparatus 11 provides a further measurement variable for monitoring. The reference position and the angle of rotation may be, in particular, a signal from a speed measuring device. It is also possible for speed information to be able to be derived from electrical data from the generator 21 and/or the converter apparatus 22, for example by determining the zero crossings.

FIG. 3C schematically illustrates that a low-frequency (for example less than 500 Hz) torsional vibration can occur in the time window F, in which case the angle of rotation then increases sharply.

FIG. 4 schematically illustrates the operating principle of an embodiment.

The starting point is the gas turbine 20 which provides the energy for the generator 21. The at least one electrical measurement variable I and the speed n (and possibly further measurement variables) are captured at the generator 21. The converter apparatus 22 converts the alternating current into direct current. If there is a shaft fracture, the variables I, n captured at the generator 21 and/or the converter apparatus 22 will change (see FIGS. 3A, 3B, 3C), with the result that, if certain criteria are exceeded, a control signal S is output to the EECs of the gas turbine 20, which control signal restricts or switches off the supply of fuel, for example.

FIG. 5 illustrates a further embodiment in which the gas turbine 20 drives the generator 21, wherein the electrical measurement variable I and the speed n are captured at the generator 21. In this case, the measurement variables are subjected to windowing F in order to determine whether certain changes in the measurement variables occur in a particular period (see FIGS. 3A, 3B, 3C).

Certain features which are characteristic of the fracture of a shaft can be extracted from this evaluation using a-priori knowledge, for example within the context of machine learning.

After the feature extraction, the data are loaded into a ring buffer memory and are then analysed.

If such an event has been detected, a control signal (for example a shut-off request) can be sent to the gas turbine 20.

List of reference signs

| | |
|---|---|
| 1 | Rotating shaft |
| 3 | First measuring apparatus (electrical variable) |
| 4 | Second measuring apparatus (speed) |
| 10 | Monitoring apparatus |
| 11 | Control apparatus |
| 20 | Gas turbine |
| 21 | Generator |
| 22 | Converter apparatus |
| 30 | Fracture point |
| 31 | Bearing |
| 32 | Starter drive |
| F | Time window |
| I | Measurement variable, electrical variable, current |
| M | Torque |
| n | Measurement variable, speed |
| S | Control signal |
| φ | Angle of rotation |

1. Monitoring apparatus for mechanical damage, in particular fracture, of a rotating shaft which is driven by a gas turbine and transmits a torque to a generator, wherein a converter apparatus coupled to the generator generates direct current,
characterized by
a first measuring apparatus for at least one electrical variable of the generator and/or of the converter apparatus during operation, wherein the torque proportionally depends on the electrical variable, and
a second measuring apparatus for the behaviour of the speed of the generator during operation,
a control apparatus which captures the electrical variable and the speed as measurement variables and,
if at least one predefinable criterion for the mechanical damage, in particular the fracture, of the shaft, in particular threshold values for the measurement variables, is exceeded or undershot, outputs at least one control signal to the gas turbine.

2. Monitoring apparatus according to claim 1, wherein the at least one electrical variable comprises at least two time-dependent current intensities on the drive side of the generator and/or the converter apparatus.

3. Monitoring apparatus according to claim 1, wherein the control apparatus captures and/or evaluates the angle of rotation or a reference position of the shaft as a further measurement variable.

4. Monitoring position according to claim 1, wherein the control apparatus captures and/or evaluates speed information relating to the shaft from an electrical measurement signal from the generator as a further measurement variable.

5. Monitoring apparatus according to claim 1, wherein a criterion for the mechanical damage, in particular the fracture, of the shaft is the drop in the electrical variable, in particular the current, within or after a predeterminable time window, and/or the exceeding of a predeterminable variation range for the electrical variable within a predeterminable time window.

6. Monitoring apparatus according to claim 1, wherein a criterion for the mechanical damage, in particular the fracture, of the shaft is the drop in the speed within or after a predeterminable time window and/or the exceeding of a predeterminable variation range for the speed within a predeterminable time window.

7. Monitoring apparatus according to claim 1, wherein a criterion for the mechanical damage, in particular the fracture, of the shaft is the increase in an angle of rotation within or after a predeterminable time window and/or the exceeding of a predeterminable variation range for the angle of rotation within a predeterminable time window.

8. Monitoring apparatus according to claim 5, wherein data from the time window are stored in at least one ring memory.

9. Monitoring apparatus according to claim 4, wherein the variation range has a frequency.

10. Monitoring apparatus according to claim 1, wherein at least one of the measurement variables is used in the time domain as a sliding mean average, a quadratic mean, a crest factor or a variance.

11. Monitoring apparatus according to claim 1, wherein at least one of the measurement variables can be evaluated in the frequency domain using a residual analysis, an order spectrum and/or a continuous optimization algorithm, in particular a TSA algorithm.

12. Monitoring apparatus according to claim 1, wherein the at least one control signal causes the gas turbine to be switched off or shut down.

13. Monitoring apparatus according to claim 1, wherein the control apparatus has means for vector control of the generator.

14. Monitoring apparatus according to claim 1, wherein the control apparatus has means for feature extraction within the context of machine learning, and the at least one control signal can be generated on the basis of the feature extraction.

15. Monitoring apparatus according to claim 1, wherein the generator is in the form of a permanently excited synchronous motor.

16. Monitoring apparatus according to claim 1, wherein the generator and the shaft are part of a drive of an aircraft, in particular in the form of a turbo generator, a hybrid electric turbo generator or part of a test apparatus.

17. Monitoring method for mechanical damage, in particular fracture, of a rotating shaft which is driven by a gas turbine and transmits a torque to a generator, wherein a converter apparatus coupled to the generator generates direct current, wherein
the profile of at least one electrical variable of the generator and/or of the converter apparatus is captured as a first measurement, wherein the torque depends on the electrical variable, and
the profile of the speed of the generator is captured as a second measurement,
wherein a control apparatus evaluates the at least one electrical variable and the speed as measurement variables and,
if predefinable criteria for the mechanical damage, in particular the fracture, of the shaft, in particular threshold values for the measurement variables, are exceeded or undershot, outputs at least one control signal for the gas turbine.

18. Monitoring method according to claim 17, wherein the control apparatus captures an angle of rotation or a reference position of the shaft as a further measurement variable.

19. Monitoring method according to claim 17, wherein the control apparatus captures the measurement variables in predetermined time windows in each case.

20. Monitoring method according to claim 17, wherein features of the measurement variables are extracted within the context of machine learning using a previously trained model, wherein at least one control signal for the gas turbine is generated on the basis thereof.
